(19) United States
(12) Patent Application Publication
(10) Pub. No.: US 2026/0312465 A1
(43) Pub. Date: Oct. 8, 2026

(54) ELECTRIC MOTOR WITH COOLING SYSTEM

(71) Applicant: SONCEBOZ MOTION BONCOURT SA, Boncourt (CH)

(72) Inventor: Cédric Mellere, Soulce-Cernay (FR)

(73) Assignee: SONCEBOZ MOTION BONCOURT SA, Boncourt (CH)

(21) Appl. No.: 19/478,004

(22) PCT Filed: Apr. 19, 2024
(86) PCT No.: PCT/EP2024/060825

§ 371 Date: Oct. 23, 2025

(30) Foreign Application Priority Data
Apr. 24, 2023 (EP) 23169599.0

(51) Int. Cl. H02K 9/19; H02K 5/20

(52) U.S. Cl. CPC H02K 9/19; H02K 5/203

(57) ABSTRACT

An electric motor including a stator, a rotor, a housing, a cooling system, and a motor drive system comprising a circuit board and a plurality of power semiconductors, the housing comprising a stator housing section comprising a circumferential wall surrounding the stator and a drive system housing section comprising a base wall positioned at an axial end of the stator housing section, the circuit board mounted on the base wall. The cooling system comprises a cooling channel for flow of a cooling liquid therein, the cooling channel bounded by wall portions that include portions of the circumferential wall and of the base wall configured such that the liquid in the cooling channel concomitantly cools both the stator and the motor drive system.

The present invention relates to an electric motor with a cooling system.

It is well known in the art that some of the elements of powerful electric motors generate heat during operation and often need to be cooled to avoid a damage due to overheating. For example, the stator and the power semiconductors of the inverter are often cooled in powerful electric motors. For example, metal-oxide-semiconductor field-effect transistors may be used as power semiconductors in the inverter. In some motor, the electronics required to operate the motor including the inverter is integrated in the motor.

In some prior art solutions, the stator and the power electronics are cooled with two separate independent cooling circuits. In other prior art solutions, the stator and the power electronics are cooled with one cooling circuit having a relatively complicated path through the housing of the motor.

In view of the foregoing, an object of the invention is to provide an electric motor comprising a cooling system that is reliable and efficient.

It is advantageous to provide an electric motor with a cooling system that is reliable and efficient, yet economical to manufacture.

It is advantageous to provide an electric motor with a cooling system that is compact.

Objects of the invention are achieved by an electric motor according to the independent claim. Dependent claims set forth embodiments of the invention.

Disclosed herein is an electric motor including a stator, a rotor, a housing, a cooling system, and a motor drive system comprising a circuit board and a plurality of power semiconductors, the housing comprising a stator housing section surrounding the stator and a drive system housing section comprising a base wall positioned at an axial end of the stator housing section, the circuit board mounted on the base wall.

The stator housing section and drive system housing section are separate parts assembled and fixed together. The stator housing section comprises an inner circumferential wall and an outer circumferential wall, the inner circumferential wall joined to the outer circumferential wall at a first axial end, both inner and outer circumferential walls extending to an assembly interface at a second axial end, the base wall assembled against said second axial end of the inner and outer circumferential walls. The cooling system comprising a cooling channel for flow of a cooling liquid therein, the cooling channel formed between and bounded by the inner circumferential wall and the outer circumferential wall and the base wall configured such that the liquid in the cooling channel concomitantly cools both the stator and the motor drive system.

In an advantageous embodiment, seals are mounted in said assembly interface between the stator housing section and the base wall, the base wall assembled sealingly against said second axial end of the inner and outer circumferential walls.

In an advantageous embodiment, the cooling system comprises a single inlet for flow of the cooling liquid into the cooling channel, and a single outlet for flow of the cooling liquid out of the cooling channel.

In an advantageous embodiment, the cooling channel completely surrounds the stator except for a separating wall between an inlet and an outlet.

In an advantageous embodiment, the separating wall between the inlet and the outlet comprises a small tolerance gap configured such that less than 5% of an overall coolant flow leaks from the inlet to the outlet directly across the separating wall.

In an advantageous embodiment, the plurality of power semiconductors are mounted on the circuit board in positions axially overlapping the cooling channel.

In an advantageous embodiment, the base wall of the drive system housing section comprises at least one heat transfer enhancement structure such as ribs, fins, pillars, protuberances, troughs or indents in the cooling channel.

In an advantageous embodiment, the cooling channel has an axial portion and a radial portion, wherein the axial portion extends along the circumferential wall and the radial portion extends over the base wall.

In an advantageous embodiment, the axial portion overlaps the stator over a length of more than 50% of an axial length of the stator.

In an advantageous embodiment, the axial portion and the radial portion of the cooling channel form together a single unconstricted channel.

In an advantageous embodiment, the axial portion and the radial portion of the cooling channel form constricted portions interconnected fluidly by a restricted fluid interconnection passage.

Further objects and advantageous features of the invention will be apparent from the claims, from the detailed description, and annexed drawings, in which:

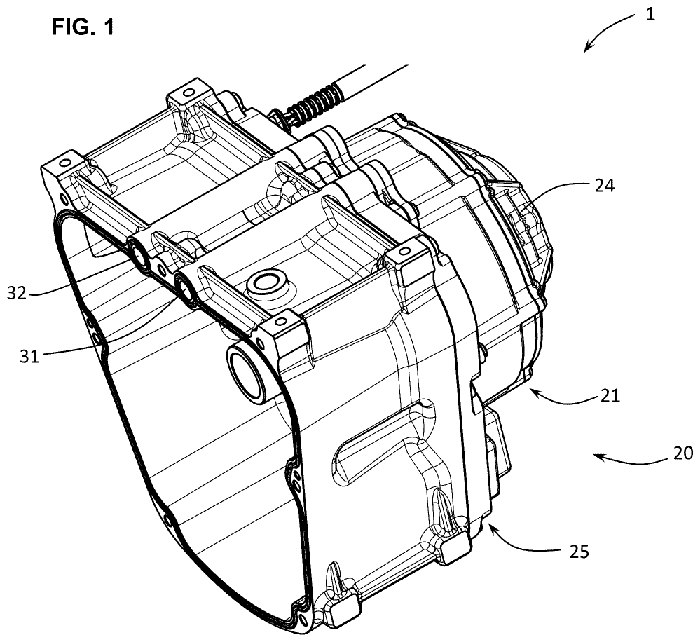

FIG. 1 is a perspective view of an electric motor according to a first embodiment of the invention;

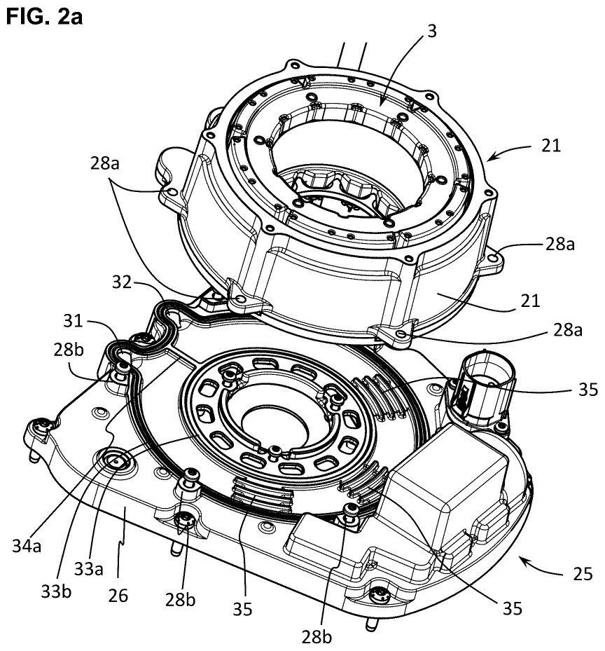

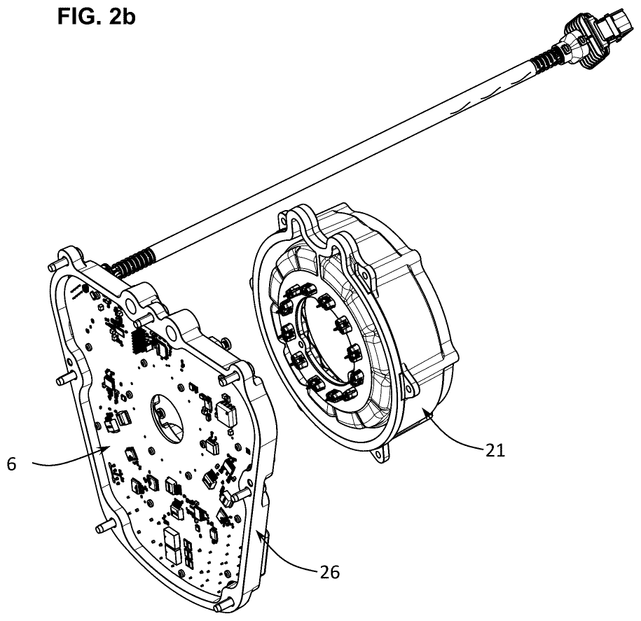

FIGS. 2a and 2b are exploded perspective views of a base portion of a stator housing and a motor drive system housing of an electric motor according to the first embodiment of the invention;

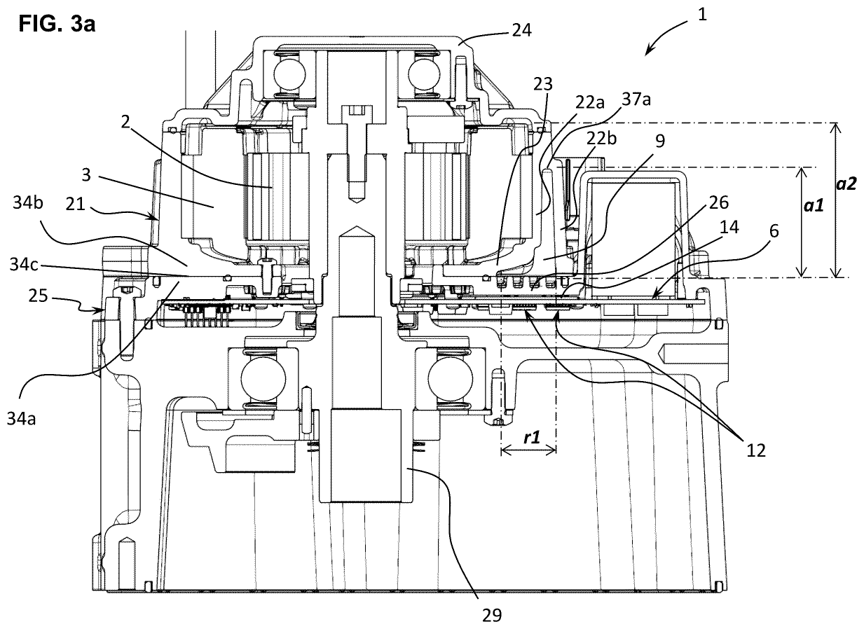

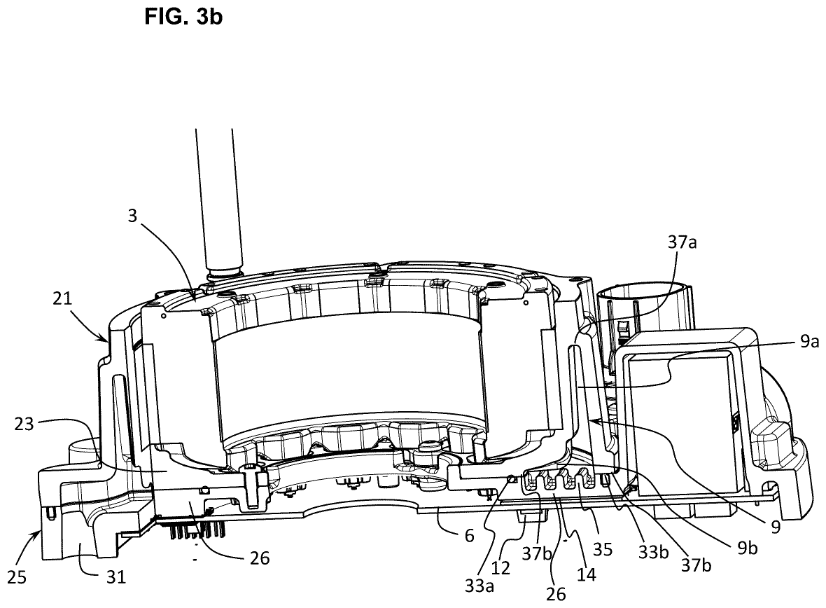

FIG. 3a is a cross-sectional view of an electric motor according to the first embodiment of the invention.

FIG. 3b is a perspective cross-sectional view of a portion of an electric motor according to the first embodiment of the invention.

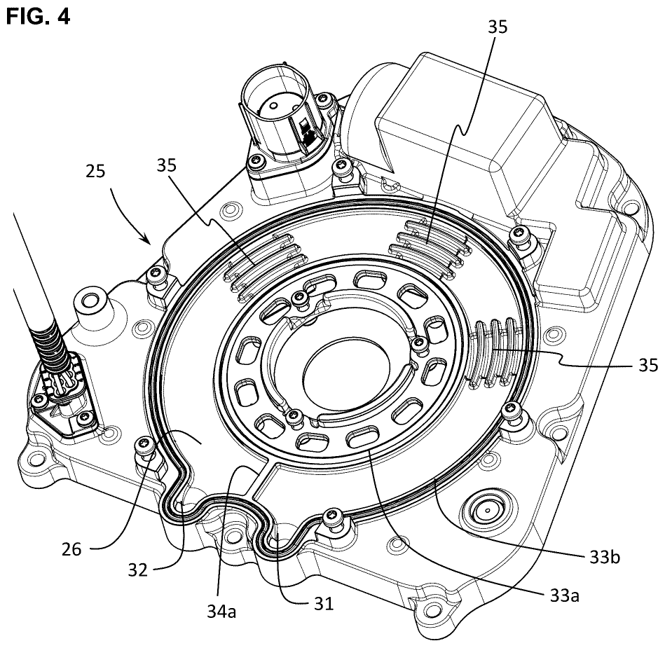

FIG. 4 is a perspective view of a motor drive system housing of an electric motor according to the first embodiment of the invention;

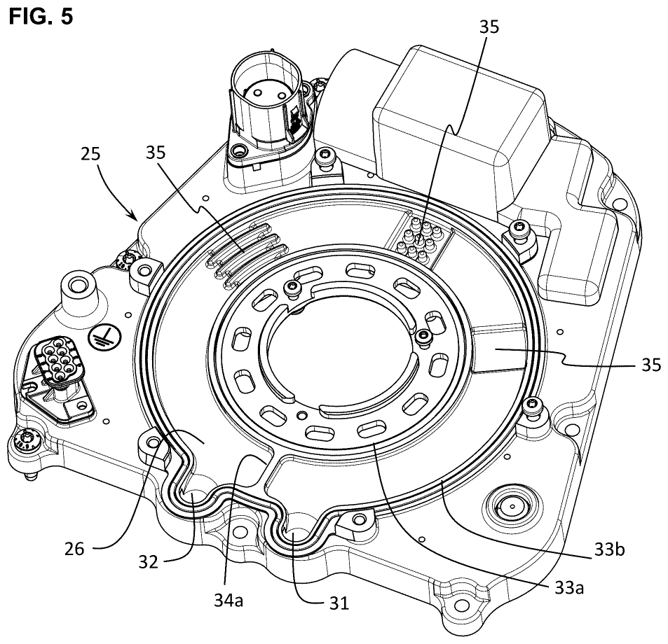

FIG. 5 is a perspective view of a motor drive system housing of an electric motor according to a variant of the first embodiment of the invention;

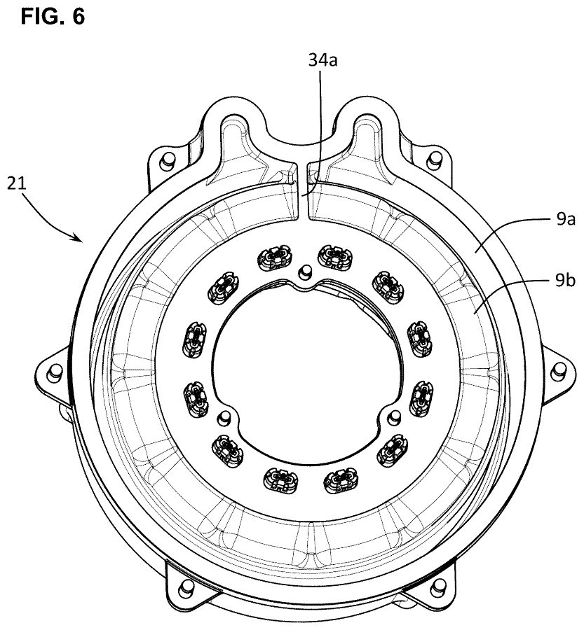

FIG. 6 is a perspective view of a stator and stator housing of an electric motor according to the first embodiment of the invention;

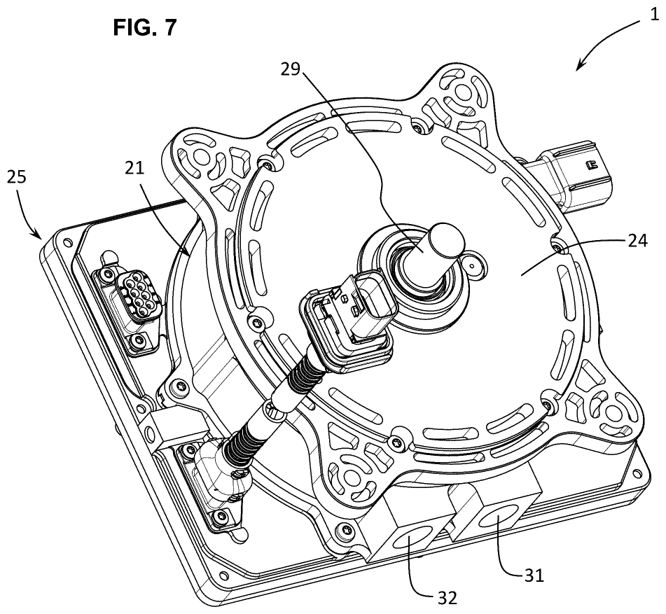

FIG. 7 is a perspective view of an electric motor according to a second embodiment of the invention;

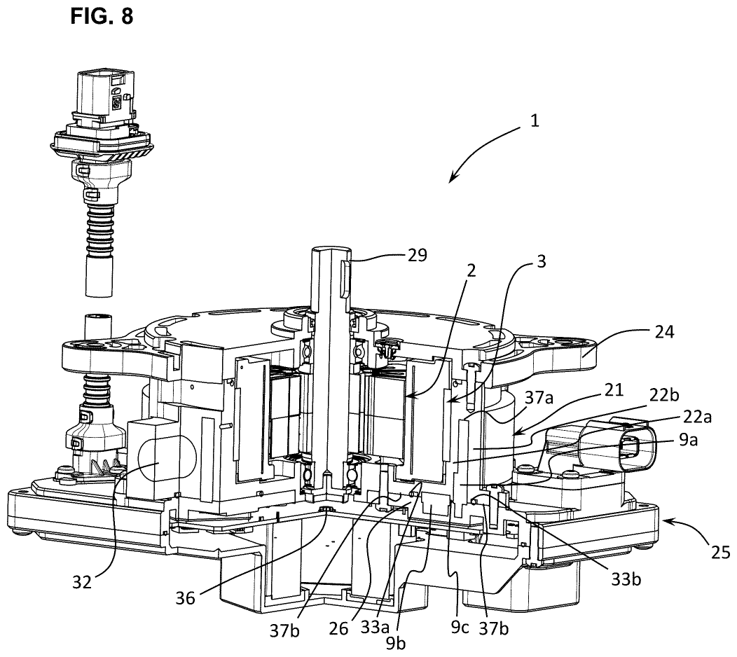

FIG. 8 is a perspective cross-sectional view of an electric motor according to the second embodiment of the invention.

Referring to the figures, an electric motor 1 according to embodiments of the invention comprises a rotor 2, a stator 3, a motor drive system and a housing 20 in which the rotor, stator and motor drive system are mounted.

The electric motor 1 further comprises a cooling system 4 including a cooling channel 9 formed within the housing 20, a cooling liquid received in and flowing through the cooling channel.

The motor drive system comprises a circuit board 6 and electronic components mounted on the circuit board including at least one inverter comprising a power semiconductor 12. The inverter supplies a drive current to an electrical phase of the electric motor, whereby a motor with a plurality of phases has a corresponding plurality of inverters.

The power semiconductor of the inverter may for instance be in the form of a bipolar transistor, an insulated-gate bipolar transistor (IGBT), a metal-oxide-semiconductor field-effect transistor (MOSFET), e.g., based on Si, SiC or GaN, or a high-electron-mobility transistor (HEMT), e.g., based on GaN as per se well known in the art of inverters for electric motors.

In certain embodiments, the electric motor 1 may be a high voltage electric motor with a nominal DC voltage above 850 V, in particular above 1000 V and in particular above 1500 V.

The housing 20 comprises a stator housing section 21 in which the stator 3 is lodged, and a drive system housing section 25 in which the circuit board 6, with the electronic components including the power semiconductors 12, of the motor drive system is lodged. The drive system housing section 25 is advantageously positioned at an axial end stator housing section 21, such that the circuit board 6 of the motor drive system is positioned adjacent an axial end of the stator 3, the axial direction being defined herein as the direction of the axis of rotation of the rotor 2. The mounting of the motor drive system over an axial end of the stator 3 advantageously provides for a compact configuration and allows for efficient cooling of both the stator and motor drive system electronic components as will be described in more detail hereinbelow.

The stator housing section 21 comprises an inner circumferential wall 22a surrounding and in contact with the stator 3. The inner circumferential wall also bounds, on a side opposite to the side in contact with the stator, the cooling channel 9 such that heat produced in the stator is mainly evacuated by conduction through the inner circumferential wall 22a into the cooling fluid flowing in the cooling channel. The inner circumferential wall 22a may continue via a bend into an end wall 23 against which an axial end of the stator 3 is seated.

The drive system housing section 25 comprises a base wall 26 positioned axially between the stator 3 and the circuit board 6 with electronic components of the motor drive system. The base wall 26 also has a portion that bounds, on a side opposite to the side in contact with the motor drive system, the cooling channel 9 such that heat produced in the motor drive system, and more particularly heat produced by the power semiconductors of the motor drive system, is mainly evacuated by conduction through the base wall 26 into the cooling fluid flowing in the cooling channel 9.

The cooling channel 9 is thus bounded by wall portions that include portions of the inner circumferential wall 22a surrounding the stator 3 and of the base wall 26 on which the motor drive system is mounted such that the cooling liquid flowing in the cooling channel serves to concomitantly cool both the stator and the motor drive system. An outer circumferential wall 22b of the stator housing section 21 bounds and closes an outer radial side of the cooling channel. The outer circumferential wall 22b is in contact with the surrounding environment and helps to dissipate heat due to convection.

The inner circumferential wall 22a is pressed against the outer diameter of the stator 3 in order to create an efficient thermal conduction from the stator 3 to the cooling channel 9 via a very low thermal resistance at the contact area. In an embodiment, the assembly between the outer diameter of the stator 3 and the inner diameter of the inner circumferential wall 22a may be effected with a press-fit, shrink-fit, or thermal-fit in order to ensure pressing contact even in conditions of thermal expansion of the housing.

In the illustrated embodiment, the stator housing section 21 and drive system housing section 25 are separate parts assembled and fixed together. Seals 33a, 33b may be mounted in the interface between the stator housing section 21 and drive system housing section 25 to ensure sealing of the cooling channel 9 and prevent leakage of liquid out of the cooling channel at the interface between the housing sections 21, 25.

The outer circumferential wall 22b is joined at a first axial end 37a to the inner circumferential wall 22b and both the inner and outer circumferential walls extend from the first axial end to a second axial end 37b situated at the assembly interface with the base wall 26. The seals 33a, 33b sealingly close the base wall against the second axial end 37b of the respective inner and outer circumferential walls 22a, 22b to form the cooling channel 9 between the inner and outer circumferential walls and base wall. This configuration provides a compact and simple stator and cooling arrangement, allowing efficient cooling for both the stator and electronics of the drive system.

The stator housing section 21 may advantageously be made as a single integrally formed part from a single block of material, for instance by molding, machining, or additive manufacturing techniques such as 3D printing techniques.

The housing 20 may comprise other parts that fit onto the stator housing section 21, such as a cap 24 covering an opposite end of the stator 3 to the end where the drive system housing section 25 is positioned.

It may be noted that an output shaft 29 of the rotor 2 may extend axially out of one side of the motor as in the illustrated embodiments, or may extend out of both sides of the motor (embodiment not shown). For instance, in the latter variant, the cap may be provided with an orifice through which the rotor shaft extends.

The motor drive system may be positioned on a side of the stator 3 through which the rotor output shaft 29 extends as in the first embodiment illustrated in FIGS. 1-6. In this embodiment, the circuit board 6 comprises a hole 30 to allow the rotor shaft to extend therethrough.

In another embodiment, the motor drive system may be positioned on a side of the stator 3 through which the rotor output shaft 29 does not extend as illustrated in FIGS. 7 and 8. In this embodiment, the circuit board 6 does not require a hole and the motor drive system may comprise a position sensor 36 mounted on the circuit board facing an axial end of the rotor shaft to detect the angular position and speed of the rotor.

In the second embodiment, an advantage of mounting the motor drive system on a side without the output shaft is the easy access to the drive system electronic components which can be repaired or replaced easily.

The cooling system 4 comprises an inlet 31 and an outlet 32 fluidly connected to the cooling channel 9.

The cooling channel 9 has an axially extending portion 9a and a radially extending portion 9b, wherein the axial portion 9a is extends along the circumferential wall 22a and the radial portion 9b extends over the base wall 26

The axial portion 9a preferably overlaps the stator 3 over a length a1 of more than 50% of an axial length a2 of the stator 3.

The radial portion 9b may be extend radially over a distance r1 such that the radial portion overlaps the stator 3 and serves to cool electronic components of the motor drive system positioned within the circumference of the motor which is dependent on the stator diameter.

In the illustrated embodiments, the cooling channel 9 substantially completely surrounds the stator 3, except for a separating wall 34b between the inlet 31 and outlet 32. The inlet and the outlet comprise an inlet mouth and an outlet mouth, respectively. The inlet and outlet mouths may be formed through the base wall 26 of the drive system housing section 25 as illustrated in FIGS. 1-6 or through the outer circumferential wall 22 as illustrated in FIGS. 7 and 8. The inlet and outlet mouths may be arranged adjacent each other, whereby a separating wall 34a, 34b is formed in the cooling channel 9 between the inlet and outlet mouths to ensure a flow of coolant liquid from the inlet mouth, around the circumference of the stator, to the outlet mouth.

In a preferred embodiment, when the stator housing section 21 and the drive system housing section 25 are assembled, a mechanical play 34c remains between the separating walls 34a, 34b. The mechanical play 34c, which is necessary for an iso-constrained assembly, allows a small quantity of coolant liquid to leak through the separating wall between the inlet 31 and outlet 32. The thickness of the mechanical play 34c may vary according to mass production dispersion and tolerances, but remains small enough such that less than 5% of the overall coolant flow leaks from inlet 31 to outlet 32 directly across the separating walls 34a, 34b.

The axial portion 9a and the radial portion 9b of the cooling channel 9 may form together an essentially single unconstricted channel as in the embodiment of FIGS. 1-6, or may form constricted portions interconnected fluidly by a restricted fluid interconnection passage 9c. The restricted fluid interconnection passage 9c allows to have a single coolant liquid circuit (with a single inlet and single outlet) in the electric motor, yet separate the bulk of the hydrodynamic coolant liquid flow around the stator from the bulk of the hydrodynamic coolant liquid flow over the base wall 26 of the motor drive system. The partially separated coolant liquid flows allows to better adjust and optimize coolant flows for evacuating heat from the motor drive system and stator according to the configuration of the motor and the heat generated by the respective motor drive system and stator.

A main source of heat generated in the motor drive system is by the power semiconductors 12. The power semiconductors are positioned on the circuit board 6, preferably axially aligned with or overlapping the cooling channel 9, in particular the radial portion 9b of the cooling channel. The heat conduction path between the power semiconductors 12 and the coolant liquid may thus be advantageously very short.

Heat transfer between the material, for instance metal, of the wall portions 22a, 26 bounding the cooling channel 9 and the coolant liquid may be increased by providing heat transfer enhancement structures 35 such as ribs, pillars, fins, indents, troughs or other protuberant or structures on the wall portions in the cooling channel 9. In an advantageous embodiment, the base wall 26 of the drive system housing section 25 comprises at least one heat transfer enhancement structure 35 in the cooling channel 9. The base wall 26 of the drive system housing section 25 may comprise a plurality of heat transfer enhancement structure 35 in the cooling channel 9 of the same type or of different types. Advantageously, heat transfer enhancement structures 35 may be placed in thermal contact with the power semiconductors, through a stack of material layers, said stack of layers being thermally conductive but electrically insulated.

List of features illustrated

Electric motor 1
Rotor 2
Output shaft 29
Stator 3
Housing 20
Stator housing section 21
Inner circumferential wall 22a
Outer circumferential wall 22b
First axial end 37a
Second axial end 37b
End wall 23
Cap 24
Fixing elements 28a
Drive system housing section 25
Base wall 26
Fixing elements 28b
Cooling system 4
Thermal interface layer 7
Heatsink 8
Cooling channel 9
Axial portion 9a
Radial portion 9b
Connection portion 9c
Inlet 31
Outlet 32
Sealing
Inner sealing 33a
Outer sealing 33b
Separating wall 34a, 34b
Small gap 34c
Heat transfer enhancement structure 35
e.g. ribs, pillars, trough
Motor drive system
Circuit board 6
Electronic components
Power semiconductor 12

1.-11. (canceled)

12. An electric motor including a stator, a rotor, a housing, a cooling system, and a motor drive system comprising a circuit board and a plurality of power semiconductors, the housing comprising a stator housing section surrounding the stator and a drive system housing section comprising a base wall, the circuit board mounted on the base wall, the stator housing section and drive system housing section being separate parts assembled and fixed together, wherein the stator housing section comprises an inner circumferential wall and an outer circumferential wall, the inner circumferential wall joined to the outer circumferential wall at a first axial end and both the inner and outer circumferential walls extend from the first axial end to an assembly interface at a second axial end, the cooling system comprising a cooling channel for flow of a cooling liquid therein, the cooling channel formed between and bounded by the inner circumferential wall and the outer circumferential wall and the base wall configured such that the liquid in the cooling channel concomitantly cools both the stator and the motor drive system.

13. The electric motor according to claim 12, wherein seals are mounted in said assembly interface between the stator housing section and the base wall, the base wall assembled sealingly against said second axial end of the inner and outer circumferential walls.

14. The electric motor according to claim 12, wherein the cooling system comprises a single inlet for flow of the cooling liquid into the cooling channel, and a single outlet for flow of the cooling liquid out of the cooling channel.

15. The electric motor according to claim 12, wherein the cooling channel completely surrounds the stator except for a separating wall between an inlet and an outlet.

16. The electric motor according to claim 14, wherein the separating wall between the inlet and the outlet comprises a small tolerance gap configured such that less than 5% of an overall coolant flow leaks from the inlet to the outlet directly across the separating wall.

17. The electric motor according to claim 12, wherein the plurality of power semiconductors are mounted on the circuit board in positions axially overlapping the cooling channel.

18. The electric motor according to claim 12, wherein the base wall of the drive system housing section comprises at least one heat transfer enhancement structure such as ribs, fins, pillars, protuberances, troughs or indents in the cooling channel.

19. The electric motor according to claim 12, wherein the cooling channel has an axial portion and a radial portion, wherein the axial portion extends along the circumferential wall and the radial portion extends over the base wall, wherein the axial portion overlaps the stator over a length (a1) of more than 50% of an axial length (a2) of the stator.

20. The electric motor according to claim 18, wherein the axial portion and the radial portion of the cooling channel form together a single unconstricted channel.

21. The electric motor according to claim 18, wherein the axial portion and the radial portion of the cooling channel form constricted portions interconnected fluidly by a restricted fluid interconnection passage.

22. The electric motor according to claim 12, wherein the stator housing section is a single integrally formed part.
